(19) United States
(12) Patent Application Publication
(10) Pub. No.: US 2020/0043038 A1
(43) Pub. Date: Feb. 6, 2020

(54) SYSTEM AND METHOD FOR TRACKING PRODUCT AND SERVICE DISCOUNTS

(71) Applicant: Christopher Pruden, Woodstock, IL (US)

(72) Inventor: Christopher Pruden, Woodstock, IL (US)

(21) Appl. No.: 16/532,055

(22) Filed: Aug. 5, 2019

Related U.S. Application Data
(60) Provisional application No. 62/714,242, filed on Aug. 3, 2018.

(51) Int. Cl. G06Q 30/02; G06Q 20/24; H04W 68/00

(52) U.S. Cl. CPC G06Q 30/0236; H04W 68/005; G06Q 20/24

(57) ABSTRACT

The present invention relates to a system and method for tracking product and service discounts. Specifically, the present invention comprises a consumer application resident on a smart phone for tracking discounts of products and services at retailers and a store application for informing consumers of discounts on products and services.

The present invention claims priority to U.S. Provisional Pat. App. No. 62/714,242, titled “System and Method for Tracking Product and Service Discounts,” filed Aug. 3, 2019, which is incorporated herein by reference in its entirety.

### TECHNICAL FIELD

The present invention relates to a system and method for tracking product and service discounts. Specifically, the present invention comprises a consumer application resident on a smart phone for tracking discounts of products and services at retailers and a store application for informing consumers of discounts on products and services.

### BACKGROUND

Consumers, of course, wish to obtain the best deals on goods and services, but oftentimes it is difficult to track sales. Specifically, within a specific location area, there may be dozens if not hundreds of retail stores that provide competing items. Because of competition to attract customers, stores often run sales, discounts, coupons, or other like promotions to attract customers to stores. Of course, a sale, discount, coupon or promotion is no good to a customer if the customer is unaware of the sale.

A need exists for a system and method for alerting customers to promotions of retail goods and/or services. Specifically a need exists for a system and method that allows consumers to be alerted to specific discounts on identified products at specific locations that are most useful to a consumer.

A need further exists for a system and method to allow retail stores the ability to communicate with customers and/or potential customers more easily and effectively. More specifically, a need exists for a system and method to allow retail stores to provide information to a centralized system regarding promotions of particular retail goods and services whereby the information is communicated to customers and/or potential customers wishing for promotion information on the particular goods and services.

### SUMMARY OF THE INVENTION

The present invention relates to a system and method for tracking product and service discounts. Specifically, the present invention comprises a consumer application resident on a smart phone for tracking discounts of products and services at retailers and a store application for informing consumers of discounts on products and services.

To this end, in an embodiment of the present invention, a system and method are provided. The system and method comprise a customer application resident on a smart phone, wherein the customer application provides alerts to the customer regarding promotions on pre-selected goods or services; and a retail store application configured to allow a retail store to provide information concerning a sales promotion on one or more goods or services.

It is, therefore, an advantage and objective of the present invention to provide a system and method for alerting customers to promotions of retail goods and/or services.

Specifically, it is an advantage and objective of the present invention to provide a system and method that allows consumers to be alerted to specific discounts on identified products at specific locations that are most useful to a consumer.

Further, it is an advantage and objective of the present invention to provide a system and method to allow retail stores the ability to communicate with customers and/or potential customers more easily and effectively.

More specifically, it is an advantage and objective of the present invention to provide a system and method to allow retail stores to provide information to a centralized system regarding promotions of particular retail goods and services whereby the information is communicated to customers and/or potential customers wishing for promotion information on the particular goods and services.

Additional features and advantages of the present invention are described in, and will be apparent from, the detailed description of the presently preferred embodiments and from the drawings.

### DETAILED DESCRIPTION OF THE PRESENTLY PREFERRED EMBODIMENTS

The present invention relates to a system and method for tracking product and service discounts. Specifically, the present invention comprises a consumer application resident on a smart phone for tracking discounts of products and services at retailers and a store application for informing consumers of discounts on products and services.

Money Miner is an app that lets a customer pick products or services the customer may want to know about, when they go on sale. For example, suppose a customer wants to know when Pepsi goes on sale. He or she can set an alert for Pepsi by zip code, store specific, and gps range.

Moreover, the customer may set an alert for a plurality of favorite shopping zip codes any time a particular pre-selected product goes on sale in those zip codes the customer will be sent an alert with the details of the sale and what store. For example, if a customer selects “Pepsi” products, and further selects a pre-defined geographic region, any time Pepsi goes on sale in that region, the customer will receive an alert regarding the sale. The customer may also select based on particular stores (such as, for example, based on address), GPS areas (such as within a certain distance of the customer's smart phone based on geolocation information tracked by the customer's smart phone) and/or website URLs.

Products may be pre-selected based on searching or by scanning the bar code, wherein the bar code may be utilized to search a database for information concerning the product desired by the customer.

Business may further utilize an application for supplying information to the system of the present invention concerning promotions, including sales, discounts or other like promotions, concerning one or more products. A business may also gain access to data on who is looking for what to go on sale, and may tailor promotions based on the popularity or desire of customers for promotions on goods and/or services. Moreover, if a retail store business is slow, the business may send out promotions on goods and/or services for limited time periods to attract customers and/or potential customers within a certain time window.

Each store may have its own profile page where it can provide promotion information on specific goods and/or services, but may also include promotion information on specialized services or products that don't contain a bar code There users may also set up alerts for those products or services!

One of the key tools for businesses is the BTW Video. This is an option for businesses to attach a 30 second or less video where they can make up their own ads and the customer can choose to view it or not. If a certain number of viewers view the ad, the business may be charged an amount of money, although any manner of billing businesses may be maintained and the present invention should not be limited as described herein.

Specific implementation details concerning the systems and methods of the present invention is provided in Appendix A, attached hereto and incorporated herein by reference in its entirety.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. A system for tracking product and service discounts comprising:
a customer application resident on a smart phone, wherein the customer application provides alerts to a customer regarding promotions on pre-selected goods or services at a retail store location; and
a retail store application configured to allow a retail store to provide information concerning a sales promotion on one or more goods or services to the customer application resident on the smart phone.

2. A method for tracking product and service discounts comprising the steps of:
providing a customer application resident on a smart phone;
providing a retail store application;
inputting information into the retail store application concerning a sales promotion on one or more goods or services, wherein the customer application resident on the smart phone provides an alert regarding the sales promotion of the one or more goods or services.
